(19) United States
(12) Patent Application Publication
(10) Pub. No.: US 2026/0081650 A1
(43) Pub. Date: Mar. 19, 2026

(54) MULTIPLE TRANSMIT ANTENNA CODEBOOK ENHANCEMENT METHODS AND SYSTEMS FOR WIRELESS COMMUNICATION

(71) Applicant: ZTE Corporation, Shenzhen (CN)

(72) Inventors: Ke YAO, Shenzhen (CN); Bo GAO, Shenzhen (CN); Xiaolong GUO, Shenzhen (CN); Yang ZHANG, Shenzhen (CN)

(21) Appl. No.: 19/342,184

(22) Filed: Sep. 26, 2025

Related U.S. Application Data
(63) Continuation of application No. PCT/CN2023/087143, filed on Apr. 7, 2023.

(51) Int. Cl. H04B 7/0456; H04B 7/06; H04W 72/232

(52) U.S. Cl. CPC H04B 7/0456; H04B 7/0639; H04W 72/232

(57) ABSTRACT

The New Radio (NR) technology of Fifth Generation (5G) wireless communication systems is configured to use multiple transmit/receive antennas to provide increased throughput and lower error rates. Embodiments of the disclosed technology are directed to configuring the uplink 8Tx candidate codebooks. In an example, the bit size and the mapping of the precoder indication are based on one or more parameters associated with capability or configuration of the wireless user equipment (UE). An example method of wireless communication includes receiving, by a wireless device from a network node, a precoder indication, and determining, based on the precoder indication, a precoder for a transmission, wherein the precoder indication indicates at least one of a number of port groups, one or more ranks, or one or more precoding information, each precoding information associated with a rank of the one or more ranks.

### CROSS-REFERENCE TO RELATED APPLICATION

This application is a continuation and claims priority to International Application No. PCT/CN2023/087143, filed on Apr. 7, 2023, the disclosure of which is hereby incorporated by reference herein in its entirety.

### TECHNICAL FIELD

This disclosure is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

Techniques are disclosed for reducing the number of candidate codebooks in systems with multiple transmit/receive (TX/RX) antennas, and to determine the bit size for precoder indications to improve the performance of wireless communication systems.

In an aspect, a method of wireless communication includes receiving, by a wireless device from a network node, a precoder indication, and determining, based on the precoder indication, a precoder for a transmission, where the precoder indication indicates at least one of a number of port groups, one or more ranks, or one or more precoding information, each precoding information associated with a rank of the one or more ranks.

In another aspect, a method of wireless communication includes transmitting, by a network node to a wireless device, a precoder indication, where the wireless device is configured to determine, based on the precoder indication, a precoder for a transmission, and where the precoder indication indicates at least one of a number of port groups, one or more ranks, or one or more precoding information, each precoding information associated with a corresponding rank of the one or more ranks.

In yet another exemplary aspect, the above-described methods are embodied in the form of processor-executable code and stored in a non-transitory computer-readable storage medium. The code included in the computer readable storage medium when executed by a processor, causes the processor to implement the methods described in this patent document.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWING

FIG. 1 shows a flowchart for an example method for wireless communication.

FIG. 2 shows a flowchart for another example method for wireless communication.

FIG. 3 shows a block diagram of an example hardware platform that may be a part of a network device or a communication device.

FIG. 4 shows an example of wireless communication including a base station (BS) and user equipment (UE) based on some implementations of the disclosed technology.

### DETAILED DESCRIPTION

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the disclosed techniques are not limited to 5G technology only, and may be used in wireless systems that implement other protocols.

The New Radio (NR) technology of Fifth Generation (5G) mobile communication systems is continuously being improved to provide higher quality wireless communication. One key feature is to support high capability wireless devices (or user equipment (UE)), such as customer premise equipment (CPE) and fixed wireless access (FWA), to improve uplink (UL) quality. One of the supported features is using up to 8 Tx (antenna ports) for UL transmission, since legacy UE can support up to 4 Tx.

The described embodiments address at least the following technical problems in existing and emerging systems:
The number of candidate codebooks for UL 8Tx is large, which may cause large overheads, and a reduction should be implemented based on some rules.
For joint indication of precoder, how to map the values of indication to the precoders and bit size determination of the precoder indication is not clear.

### 1 Overview of Precoding Information and Coherence Levels

In some embodiments, a wireless device (e.g., the UE) reports capability of coherent level or number of port group(s), and the network node (e.g., base station, gNB, etc.) configures or indicates coherent level or number of port group(s) (set).

As used herein, the coherence level reflects the coherent capability among port groups. If 2 ports are coherent, the phase between the 2 ports could be controlled by the transmitter, e.g., a UE when the 2 ports are transmit ports of the UE. If 2 ports are not coherent, the phase cannot be assumed to be controlled by the transmitter. For a UE supporting more than 2 ports, some ports can be coherent, while some ports are not coherent; consequently, from perspective of UE, it has partially coherent ports. For 8Tx, i.e., 8 ports, the coherent level can be fully coherent which means all 8 ports are coherent, partially coherent 1 means there are 2 (4Tx, or 4-port) groups, partially coherent 2 means there are 4 (2Tx, or 2-port) groups, and non-coherent means no ports are coherent. Ports may be coherent within a group, or ports may not be coherent among groups. In some cases, the coherence level corresponds to number of port groups. The full coherence level corresponds to 1 group, i.e., Ng=1, a first type of partial coherence level corresponds to 2 groups, i.e., Ng=2, a second type of partial coherence corresponds to 4 groups, i.e., Ng=4, and non-coherence corresponds to 8 groups, i.e., Ng=8.

In some embodiments, the network node indicates a precoder for a transmission by a joint-coded indication in a DCI. The joint coded indication may indicate rank information and precoding information to form a precoder. The wireless device receives a coherent or number of port group(s) (set) and the DCI, and determines a precoder for the transmission.

In some embodiments, the precoding information can be a set of parameter values, a transmit precoding matrix indicator (TPMI) indicating a set of parameter values, or one or more TPMI. Herein, each TPMI corresponds to a non-zero rank. This is summarized in Table 1.

TABLE 1
Summary of number of groups indication and TPMI

| Indication | | TPMI and/or rank (number |
|---|---|---|
| # of groups | | of layers) indication: |
| {1, 2, 4, 8} | For 1 group (full-coh) | One field: rank 1~8 + 8Tx TPMI |
| | For 2 groups (partial- | 2 fields: each indicating rank 0~4 + |
| | coh1) | 4Tx TPMI |
| | For 4 groups (partial- | 4 fields: each indicating rank 0~2 + |
| | coh2) | 2Tx TPMI |
| | For 8 groups (non-coh) | 8 fields, each indicating rank 0~1 |
| | | or 1 8-bit field |

As used herein, the term rank splitting, or number of layers splitting, corresponds to the rank that is split referring to a number of layers for 8 Tx ports (all of the port groups), or a sum of the one or more ranks (each rank corresponding to a port group).

### 2 Embodiment 1. Restriction of Rank Combinations

In some embodiments, and for partial or non-coherent codebooks, a baseline scheme uses the full flexibility of rank combination and TPMIs. However, in reality, full flexibility may cause a large number of candidate precoders and large overhead for indication of precoder. The described embodiments describe restriction that can be applied to rank combination as follows.

The group-balancing rule. When using the group-balancing (or group-balanced) rule, an almost even split of layers amongst port groups is implemented. For example, 4 ports can be split into 2 and 2 for 2-port groups, and 5 ports can be split into 2 and 3 for 2-port groups.

In some embodiments, if rank permutation for rank splitting and rank indication is supported, 5 can be split into 3 and 2, i.e., 3+2, for 2 port groups, or 2 and 3, i.e., 2+3. This implies that the port group index is sensitive to layer splitting. 2+3 results in port group index 0 having 2 layers, while port group index 1 having 3 layers, whereas 3+2 results in port group index 0 having 3 layers, and port group index 1 having 2 layers.

Whether rank permutation is supported can be based on a predetermined rule or configured by a parameter from the network node. In an example, the predetermined rule can be lower port group index having the same or fewer number of layers than a higher port group index when rank/layer splitting. For example, 5 is split into 2+3.

The group-selection rule. When using the group-selection rule, the layers are distributed among as few groups as possible. For example, 4 ports can be split into 4+0, and 5 ports can be split into 4+1. If supporting 2 groups for 8 ports, one group that has 4 ports can support at most 4 layers. If supporting 4 groups, one group can support at most 2 layers.

In some embodiments, whether 4 ports can also be split into 0+4, or 5 ports can be split into 1+4, depends on a rank permutation rule. If the rank permutation rule is supported, 4 can also be split into 0+4 or 4+0, and 5 can also be split into 1+4 or 4+1.

Furthermore, the group-selection rule may be only for each 4-port group (e.g., may correspond to 2 panels in the UE, with 2 back-to-back directions) or only for each 2-port group (e.g., may correspond to 4 panels in UE, with 4 different directions).
For 4-port group-selection, 2-port group-selection is not accommodated. This results in 1 pair of 2-port groups within one 4-port group still use the group-balanced rule unless additionally configured to enable group-selection.
This also results in for the 1-port group, the group-selection rule for 4-port and 2-port group-selection is not accommodated, unless additionally configured.

In some embodiments, an explicit indication can be used. Alternatively, an implicit method may be adopted wherein the highest coherence level can be used to determine which level the group-selection should be applied to. For example:
If the highest coherence level is full coherence, there is no need to support the group-selection rule for any one port group.
If the highest coherence level is partial-1 coherence, support the group-selection rule for 4-port group, but there is no need to support it for 2-port groups.
If the highest coherence level is partial-2 coherence, support the group-selection rule for 2-port group.

Herein, it is assumed that the full coherence level is greater than the partial-1 coherence level, which is greater than the partial-2 coherence level, which is greater than the non-coherence level.

In some embodiments, both the group-selection rule and the group-balancing rule can be implemented based on the provided configuration.

Option 1. Only one rule is configured, and the candidate codebooks are selected based on only on the enabled rule.

group-selected
...

or

group-balanced
...

Option 2. The group-balancing rule is always enabled, and the configuration specifies whether the group-selection rule is supported on top of the group-balanced rule.

group-selected + group-balanced
...

or

group-balanced
...

For a specified number of port groups (N_{g}) equaling 2, 4 or 8, there may be different sets for different configurations.

For option 1, there are two sets for the two rules.

For option 2, two sets for balanced rule and balancing+selection rules

For 4-port group: group-selected + group-balanced
...

or

For 2-port group: group-balanced
...

### 3 Embodiment 2. Restriction of Nested Codebook Structures

In some embodiments, whether a nested codebook structure is used is also related to the number of candidate codebooks. A UE with greater coherence capabilities could support not only codebooks of the higher coherence levels, but also codebooks of lower coherence levels. For example, for a 4-port UE, codebooks can be identified as having a full coherence part, a partial coherence part, and a non-coherent part. For a UE that supports the full coherence level, the codebook for full coherence, partial coherence, and non-coherence can be used, and the coherence level configured by the gNB (and transmitted to the UE) is full, partial and non-coherent. For a UE that supports partially coherent level, the codebook for partial coherence and non-coherence can be used, and the coherence level configured by the gNB is partial and non-coherent. For a UE that supports the non-coherence level, the available codebooks can only include the non-coherent part. A nested codebook structure means the available codebooks for a UE with a specific coherence level include the codebooks for its highest coherence level, and the codebooks for the coherence levels lower than its highest coherence level.

However, for 8Tx UE, there are four levels of coherence, and for each coherence level, there may be hundreds of codebooks. If a nested structure is adopted, there are typically lots of available (or candidate) codebooks that may cause an unnecessarily large overhead. Some of the described embodiments are directed to reducing the number of candidate codebooks, and are configured to support the following schemes:
Scheme 1. One or more Ng values are configured based on the UE capability, and the candidate codebooks are determined based on the configured Ng value(s). Alternatively, one or more coherent levels are configured based on UE capability, and the candidate codebooks are determined based on the configured coherent level(s). Note that there is no need to support all codebooks for Ng values larger than the configured Ng, and no need to support all codebooks for coherence levels lower than the configured coherence level.
Scheme 2. Determine the candidate codebooks based on UE capability using the relationship between the group-balanced rule and the group-selection rule.
   For full coherence being the highest level, codebooks for Ng=1, 2, 4 and 8 are allowable, with only group-balanced rule.
   For partial-1 coherence being the highest level, codebooks for Ng=2, 4 and 8 are allowable, with only group-selection rule only for 4-port group, and other kinds of port groups with group-balanced rule.
   For partial-2 coherence being the highest level, codebooks for Ng=4 and 8 are allowable, with only group-selection rule only for 2-port group, and other kinds of port groups with group-balanced rule.
   For non-coherence being the highest level, codebooks for Ng=8 are allowable, and the group-balanced rule and the group-selection rule are the same.

### 4 Embodiment 3. Codebook Definition and Signaling

### 4.1 Indication of Number of Port Groups, TPMI and Rank

In some embodiments, a joint-coded indication scheme is implemented. Herein, the gNB indicates a jointly coded indication for the number of port groups, TPMI and rank for each port group to the UE to indicate a precoder for a transmission, e.g., via DCI. The UE receives this jointly coded indication to determine a precoder for a transmission.

In some embodiments, the jointly coded indication indicates one entry of one or a combination of more than one table. For example:
For one table, the single table includes at least one of the following parts: a full coherence part (i.e., Ng=1), a partial-1 coherence part (i.e., Ng=2), a partial-2 coherence part (i.e., Ng=4), or a non-coherent part (i.e., Ng=8).
For multiple tables, each table corresponds to at least one of the following parts: a full coherence part (i.e., Ng=1), a partial-1 coherence part (i.e., Ng=2), a partial-2 coherence part (i.e., Ng=4), or a non-coherent part (i.e., Ng=8). In an example, four tables can be used with one each for Ng=1, 2, 4 and 8. In another example, two tables can be used with a first table for Ng=1 and a second table for Ng=2, 4 and 8.

In some embodiments, the bit size of the jointly coded indication depends on the number of entries of the one or more tables available for the UE. The number of entries can be the sum of the number of available entries in the one or more tables. This results in the jointly coded indication indicating a codebook from one table, or a combination of several tables, and based on the available entries. The combination may be only a logical one for determining the entry from several parts. The available entries can be determined according to one or more of the following aspects:
maxRANK, a combination/list of maxRANK,
port group index sensitive (rank-restriction/indication permutation) rule,
group-selection rule and/or group-balancing rule,
nested construction rule,
TPMI reduction rule, or
a mode configured from a set of predefined modes to determine at least one of the following aspects: the port group index sensitive (rank-restriction/indication permutation) rule, the group-selection rule and/or group-balancing rule, the nested construction rule, or TPMI reduction rule. Alternatively, or in addition, the mode may be relevant to the UE antenna layout (e.g., Ng, same or different directions), and can be reported by UE to gNB.

In the above-described embodiments and examples, a codebook refers to a precoder or a precoding matrix.

### 4.2 Codebook Definitions

In some embodiments, multiple tables or mixed (or nested) tables are used to define entries corresponding to codebooks that can be selected.
Option 1. A single mixture table corresponding to all the coherence levels is defined and a rule to select part or all of the entries in the table is defined for different nested schemes. For example, a legacy nested construction, a flexible set of parts (e.g., part3+part4), and the like for the table shown below may be used.

| | |
|---|---|
| part4 | non coherence |
| part3, Ng = 4 | partial-2 coherence |
| part2, Ng = 2 | partial-1 coherence |
| part1, Ng = 1 | full coherence |

Option 2. Several tables are defined individually, each one for one of the Ng values, e.g., non-coherence, partial-2 coherence, partial-1 coherence, and full coherence, and the number of entries for indication signaling is based on the Ng configuration and a nested scheme. One or more of the following options may be implemented.
   Each part may have a complete set of codebooks based on one or more parameters that include maxRANK, a combination/list of maxRANK, port group index sensitive (rank-restriction/indication permutation) rule, a group-selection rule and/or group-balanced rule, nested construction rule, or TPMI reduction rule. A UE can determine the available codebooks (entries) based on its own capabilities or configurations.
   For each part, there are different set for different number entries for different cases of UE. For example, for each mode value, a set of entries are provided, and a UE determines the available codebooks based its own mode.
   The full coherence part may have a variable size for the candidate codebook set, which depends on N1/N2/O1/O2, wherein N1 and N2 correspond to the numbers of rows and columns of antenna elements in a panel (antenna panel), respectively, and O1 and O2 correspond to the respective oversampling.

| | |
|---|---|
| part4 | non-coherence |
| part3, Ng = 4 | partial-2 coherence |
| part2, Ng = 2 | partial-1 coherence |
| part1, Ng = 1 | full coherence |

Option 3. Several tables (or different columns in one table, as in the legacy case) are defined, each for different combinations of non-coherence, partial-2 coherence, partial-1 coherence, and full coherence. One table is determined for indication based on Ng configuration, and the nested scheme. An example is shown below.

| Highest | | Highest | | Highest | | Highest | |
|---|---|---|---|---|---|---|---|
| full-coh | | partial_1-coh | | partial_2-coh | | non -coh | |
| part4 | non coh | part4 | non coh | part4 | non coh | part4 | non coh |
| part3 | partial_2 | part3 | partial_2 | part3 | partial_2 | | |
| | coh | | coh | | coh | | |
| part2 | partial_1 | part2 | partial_1 | | | | |
| | coh | | coh | | | | |
| part1 | full coh | | | | | | |

Full coherence or Ng=1. The precoding information can be a set of parameter values which comprises at least one of i_{1,1}, i_{1,2}, i_{1, 3}, or i₂. The value range of i_{1,1}, i_{1,2}, can be determined according to N1, N2 and corresponding oversampling O1, O2. N1/N2 can be configured. N1 and N2 are numbers of rows and columns of antenna elements in a panel (antenna panel) respectively. O1/O2 can be configured or determined according to N1/N2, or the number of layers. i_{1, 3} which is a gap, and i₂ which is a phase are determined as for DL codebook.

An example of a table for full coherence is shown below.

| TPMI_RANK | # of layers | precoding info (Value combinations of |
|---|---|---|
| field | (RANK) | i_{1, 1}, i_{1, 2}, i_{1, 3}, or i₂ for each # of layers) |
| 0-3 | 1 | i_{1, 1} = 0, i_{1, 2} = 0, i_{1, 3} = 0, or i₂ = 0-3 |
| 4-7 | 1 | i_{1, 1} = 1, i_{1, 2} = 0, i_{1, 3} = 0, or i₂ = 0-3 |
| . . . | | |
| 16-17 | 2 | i_{1, 1} = 0, i_{1, 2} = 0, i_{1, 3} = 0, or i₂ = 0-1 |
| 18-19 | 2 | i_{1, 1} = 0, i_{1, 2} = 0, i_{1, 3} = 1, or i₂ = 0-1 |
| . . . | | |

Herein, the UE determines value domain of each parameters of i_{1,1}, i_{1,2}, i_{1, 3}, i₂ for each rank, the value domain of a parameter can be same or different for different ranks. The TPMI and rank values are jointly indexed according to the following orders:
from rank 1 to the largest rank, e.g., 8
for each rank, combinations of values of the four parameters are ordered in a predefined rule. E.g., i₂ increasing firstly, i_{1, 3} secondly, then i_{1,2}, and at last i_{1,1}. or the predefined rule can also be other orders, like i_{1, 3} increasing firstly, i₂ secondly, then i_{1,2}, and at last i_{1,1}.

### Partial-1 Coherence or Ng=2.

In an example, rank 1 and 8 can have the following rank splitting scheme, also called as number of layers splitting.

| | All layers in one | Layers split across 2 |
|---|---|---|
| Rank | Antenna Group | Antenna Groups |
| 1 | (1, 0), (0, 1) | — |
| 8 | — | (4, 4) |

Ranks 2 to 7 can have the following rank splitting scheme, also called as number of layers splitting.

| | | | Layers split |
|---|---|---|---|
| | | | across 2 Antenna |
| | All layers in one | Layers split across 2 | Groups with group |
| Rank | Antenna Group | Antenna Groups | selection rule |
| 2 | //(2, 0)//, [[(0, 2)]] | — | |
| 2 | — | #(1, 1)# | |
| 3 | //(3, 0)//, [[(0, 3)]] | — | |
| 3 | — | //(2, 1)//, #(1, 2)# | |
| 4 | //(4, 0)//, [[(0, 4)] | — | |
| 4 | — | #(2, 2)#, (3, 1), (1, 3) | |
| 5 | — | #(2, 3)#, //(3, 2)// | //(4, 1)//, {{(1, 4)}}, |
| 6 | — | #(3, 3)# | //(4, 2)//, {{(2, 4)}}, |
| 7 | — | //(4, 3)//, #(3, 4)# | |

In the above table, entries within single hashmarks #⋅# correspond to group-balanced rule splitting, entries within double brackets [[⋅]] correspond to one group rule, entries within double curly braces {{⋅}} correspond to group-selection, and entries within slashes //⋅// correspond to group index sensitive ones for each rule accordingly.

In another example, the jointly coded indication can be partly rank restricted as shown in the example below, which follows the notations in the previous table.

| Joint coded | | | |
|---|---|---|---|
| indication Bit | | | |
| field mapped | | | |
| to index | | 1^{st} group | 2^{nd} group |
| 0 | Rank 1: (1, 0) | 1 layer: TPMI = 12 | 0 layer |
| 1 | | 1 layer: TPMI = 13 | 0 layer |
| . . . | | . . . | . . . |
| 15 | | 1 layer: TPMI = 27 | 0 layer |
| 16 | Rank 1: (0, 1) | 0 layer | 1 layer: TPMI = 12 |
| 17 | | 0 layer | 1 layer: TPMI = 13 |
| . . . | | . . . | . . . |
| 31 | | 0 layer | 1 layer: TPMI = 27 |
| 32~32 + 255 | Rank 2: #(1, 1)# | 1 layer: TPMI = 12~27 | 1 layer: TPMI = 12~27 |
| +8 | Rank 2: //(2, 0)// | 2 layers: TPMI = 14~21 | 0 layer |
| +8 | Rank 2: [[(0, 2)]] | 0 layer | 2 layers: TPMI = 14~21 |
| | Rank 3: #(1, 2)# | 1 layer: TPMI = 12~27 | 2 layers: TPMI = 14~21 |
| | Rank 3: //(2, 1)// | | |
| | Rank 3: //(3, 0)// | 3 layers: TPMI = 3~6 | 0 layer |
| | Rank 3: [[(0, 3)]] | 0 layer | 3 layers: TPMI = 3~6 |
| | | . . . | . . . |
| | Rank 8: (4, 4) | 4 layers: TPMI = 3 | 4 layers: TPMI = 3 |
| | | 4 layers: TPMI = 4 | 4 layers: TPMI = 4 |
| | | 4 layers: TPMI = 3 | 4 layers: TPMI = 4 |
| | | 4 layers: TPMI = 4 | 4 layers: TPMI = 3 |

### Partial-2 Coherence or Ng=4.

Some rules can be reused as for Ng=2, like for layer splitting, whether balanced manner or converged manner or both can be supported; for TPMI candidates reduction, whether some reduction happens for some higher rank.

In an example, the table for two 4Tx partial-coherence TPMI to indicate codebooks for Ng=4 is shown below, which follows the notations in the previous tables.

| | All layers in one | Layers split across 2 | 2 4Tx partial- |
|---|---|---|---|
| Rank | Antenna Group | Antenna Groups | coh TPMI |
| 1 | (1, 0), (0, 1) | — | 1/0/0/0 |
| | | | 0/1/0/0 |
| | | | 0/0/1/0 |
| | | | 0/0/0/1 |
| 8 | — | (4, 4) | 2/2/2/2 |
| | All layers in one Antenna | | |
| | Group Or Layers split | | |
| | across 2 Antenna Groups | Layers split across 2 | |
| Rank | with group selection rule | Antenna Groups | |
| 2 | //(2, 0)//, [[(0, 2)]] | — | 1/1/0/0 (or 1/0/1/0) |
| | | | 0/0/1/1 (0/1/0/1) |
| 2 | — | #(1, 1)# | 1/0/1/0 |
| | | | 1/0/0/1 |
| | | | 0/1/1/0 |
| | | | 0/1/0/1 |
| 3 | //(3, 0)//, [[(0, 3)]] | — | 1/2/0/0, 0/0/1/2 |
| 3 | — | //(2, 1)//, #(1, 2)# | 1/1/1/0 1/0/1/1 |
| | | | 1/1/0/1 0/1/1/1 |
| 4 | //(4, 0)//, [[(0, 4)]] | — | 2/2/0/0 0/0/2/2 |
| 4 | — | #(2, 2)#, (3, 1), (1, 3) | 1/1/1/1, 2/1/1/0, 1/0/2/1 |
| 5 | //(4, 1)//, {{(1, 4)}}, | #(2, 3)#, //(3, 2)// | 2/2/1/0, 1/0/2/2, 1/1/2/1, |
| | | | 2/1/1/1 |
| | | | 2/2/0/1, 0/1/2/2, |
| 6 | //(4, 2)//, {{(2, 4)}}, | #(3, 3)# | 2/2/1/1, 1/1/2/2, 2/1/2/1 |
| 7 | — | //(4, 3)//, #(3, 4)# | 2/2/2/1, 2/1/2/2 |

For the following cases:
Issue 1. If using 2-group to support Ng=4, rank combination set is same as Ng=2, or are more needed?
Issue 2. If using 2-group to support Ng=8, i.e., non-coherence, less rank combinations may be needed.

The following solutions are used:
Solution 1. The same rank combination with same restriction, or without any restriction for Ng=2, 4 and 8, or for full coherence, partial-1 coherence, partial-2 coherence, or non-coherence.
Solution 2. Different rank restrictions for Ng=2, 4, and 8 respectively.
   Ng=2 or partial-1 coherence can only support part of the set
   Ng=4 or partial-2 coherence may need more than rank splitting for Ng=2, or all kinds of rank splitting schemes
   Ng=8 or non-coherence may need part of set for typical use cases of port selection. Herein, the highest level of coherent or lowest Ng can be used to determine rank splitting candidates using 2 groups for Ng=8, or non-coherence. In an example, for a highest level of full coherence, all layers in one antenna group, or layers split across 2 antenna groups with group selection rule can be used; for a highest level of partial-1 coherence, partial-2 coherence, or non-coherence, layers split across 2 antenna groups can be used.

Whether Solution 1 or Solution 2 is used may depend on a predefined rule, or an explicit configuration, or an implicit parameter (e.g., nested parameter).

Different options for a jointly coded indication for Ng=4 are shown below, which follows the notations in the previous tables.

Option 1 with 4 groups:

| Jointly coded | | | | | |
|---|---|---|---|---|---|
| indication Bit | | | | | |
| field mapped | | | | | |
| to index | | 1^{st} group | 2^{nd} group | 3^{rd} group | 4^{th} group |
| 0~3 | Rank 1: | 1 layer: | 0 layer | 0 layer | 0 layer |
| | #1/0/0/0#; | TPMI = 2~5 | | | |
| . . . | #0/1/0/0#; | 0 layer | 1 layer: | 0 layer | 0 layer |
| | #0/0/1/0#; | | TPMI = 2~5 | | |
| | #0/0/0/1# | . . . | . . . | . . . | . . . |
| 15 | | 0 layer | 0 layer | 0 layer | 1 layer: |
| | | | | | TPMI = 2~5 |
| . . . | Rank 2: | 1 layer: | 1 layer: | 0 layer | 0 layer |
| | #1/1/0/0#; | TPMI = 2~5 | TPMI = 2~5 | | |
| | #1/0/1/0#; | 1 layer: | 0 layer | 1 layer: | 0 layer |
| | #1/0/0/1#; | TPMI = 2~5 | | TPMI = 2~5 | |
| | #0/1/1/0#; | . . . | . . . | . . . | . . . |
| | #0/1/0/1#; | 2 layers: | 0 layer | 0 layer | 0 layer |
| | #0/0/1/1#; | TPMI = 1~2 | | | |
| | [[2/0/0/0]]; | . . . | . . . | . . . | . . . |
| | [[0/2/0/0]]; | | | | |
| | [[0/0/2/0]]; | | | | |
| | [[0/0/0/2]] | | | | |
| | Rank 3: | 1 layer: | 1 layer: | 1 layer: | 1 layer: |
| | #1/1/1/0#; | TPMI = 2~5, | TPMI = 2~5, | TPMI = 2~5, | TPMI = 2~5, |
| | #1/1/0/1#; | 2 layers: | 2 layers: | 2 layers: | 2 layers: |
| | #1/0/1/1#; | TPMI = 1~2, | TPMI = 1~2, | TPMI = 1~2, | TPMI = 1~2, |
| | #0/1/1/1#; | or 0 layer | or 0 layer | or 0 layer | or 0 layer |
| | [[1/2/0/0]]; | | | | |
| | [[1/0/2/0]]; | | | | |
| | [[1/0/0/2]]; | | | | |
| | [[0/1/2/0]]; | | | | |
| | [[0/1/0/2]]; | | | | |
| | [[0/0/1/2]] | | | | |
| | Rank 4: | 1 layer: | 1 layer: | 1 layer: | 1 layer: |
| | #1/1/1/1#; | TPMI = 2~5, | TPMI = 2~5, | TPMI = 2~5, | TPMI = 2~5, |
| | [[2/2/0/0]]; | 2 layers: | 2 layers: | 2 layers: | 2 layers: |
| | [[2/0/2/0]]; | TPMI = 1~2, | TPMI = 1~2, | TPMI = 1~2, | TPMI = 1~2, |
| | [[2/0/0/2]]; | or 0 layer | or 0 layer | or 0 layer | or 0 layer |
| | [[0/2/2/0]]; | | | | |
| | [[0/2/0/2]]; | | | | |
| | [[0/0/2/2]] | | | | |
| . . . | . . . | . . . | . . . | . . . | . . . |
| | Rank 8: | 2 layers: | 2 layers: | 2 layers: | 2 layers: |
| | 2/2/2/2 | TPMI = 1~2 | TPMI = 1~2 | TPMI = 1~2 | TPMI = 1~2 |

Option 2 with 2 groups (2 4Tx TPMI):

| Bit field mapped | | | |
|---|---|---|---|
| to index | | 1^{st} group | 2^{nd} group |
| 0~7 | Rank 1: (1, 0) | 1 layer: TPMI = 4~11 | 0 layer |
| +8 | Rank 1: (0, 1) | 0 layer | 1 layer: TPMI = 4~11 |
| +64 | Rank 2: #(1, 1)# | 1 layer: TPMI = 4~11 | 1 layer: TPMI = 4~11 |
| . . . | Rank 2: //(2, 0)// | 2 layers: TPMI = 6~13 | 0 layer |
| | Rank 2: [[(0, 2)]] | 0 layer | 2 layers: TPMI = 6~13 |
| | Rank 3: #(1, 2)# | 1 layer: TPMI = 4~11 | 2 layers: TPMI = 6~13 |
| | Rank 3: //(2, 1)// | 2 layers: TPMI = 6~13 | 1 layer: TPMI = 4~11 |
| | Rank 3: //(3, 0)// | 3 layers: TPMI = 1~2 | 0 layer |
| | Rank 3: [[(0, 3)]] | 0 layer | 3 layers: TPMI = 1~2 |
| | | . . . | . . . |
| | Rank 8: (4, 4) | 4 layers: TPMI = 1~2 | 4 layers: TPMI = 1~2 |

### Non-Coherence or Ng=8.

The following example is for 2 groups (2 4Tx TPMI)

| Bit field mapped | | | |
|---|---|---|---|
| to index | | 1^{st} group | 2^{nd} group |
| 0~7 | Rank 1: (1, 0) | 1 layer: TPMI = 0~3 | 0 layer |
| +8 | Rank 1: (0, 1) | 0 layer | 1 layer: TPMI = 0~3 |
| +64 | Rank 2: (1, 1) | 1 layer: TPMI = 0~3 | 1 layer: TPMI = 0~3 |
| . . . | Rank 2: [[(2, 0)]] | 2 layers: TPMI = 0~5 | 0 layer |
| | Rank 2: [[(0, 2)]] | 0 layer | 2 layers: TPMI = 0~5 |
| | Rank 3: #(1, 2)# | 1 layer: TPMI = 0~3 | 2 layers: TPMI = 0~5 |
| | Rank 3: //(2, 1)// | 2 layers: TPMI = 0~5 | 1 layer: TPMI = 0~3 |
| | Rank 3: //(3, 0)// | 3 layers: TPMI = 0 | 0 layer |
| | Rank 3: [[(0, 3)]] | 0 layer | 3 layers: TPMI = 0 |
| | | . . . | . . . |
| | Rank 8: (4, 4) | 4 layers: TPMI = 0 | 4 layers: TPMI = 0 |

In some embodiments, the predefined precoder sets for UL 4Tx and UL 2Tx for rank 1-4 and rank 1-2 are shown as in the following table respectively.

Table 6.3.1.5-3: Precoding matrix W for single-layer transmission using four
antenna ports with transform precoding disabled.

| TPMI | W | | | | | | | |
|---|---|---|---|---|---|---|---|---|
| index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ | — | — | — | — |

Table 6.3.1.5-5: Precoding matrix W for two-layer transmission using four antenna
ports with transform precoding disabled.

| TPMI | W | | | |
|---|---|---|---|---|
| index | (ordered from left to right in increasing order of TPMI index) | | | |
| 0-3 | $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 0 \\ 0 & 1\end{matrix} ]$ | $\frac{1}{2} [ \begin{matrix}0 & 0 \\ 1 & 0 \\ 0 & 1 \\ 0 & 0\end{matrix} ]$ |
| 4-7 | $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ |
| 8-11 | $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - j & 0 \\ 0 & - 1\end{matrix} ]$ | $\frac{1}{2} [ \begin{matrix}1 & 0 \\ 0 & 1 \\ - 1 & 0 \\ 0 & - j\end{matrix} ]$ | $\frac{1}{2} [ \begin{matrix}1 & 0 \\ 0 & 1 \\ - 1 & 0 \\ 0 & j\end{matrix} ]$ |
| 12-15 | $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ j & 0 \\ 0 & - 1\end{matrix} ]$ | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ |
| 16-19 | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ |
| 20-21 | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - 1\end{matrix} ]$ | — | — |

Table 6.3.1.5-6: Precoding matrix W for three-layer transmission using four
antenna ports with transform precoding disabled.

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 \\ 0 & 1 & 0 \\ 0 & 0 & 1 \\ 0 & 0 & 0\end{matrix} ]$ | $\frac{1}{2} [ \begin{matrix}1 & 0 & 0 \\ 0 & 1 & 0 \\ 1 & 0 & 0 \\ 0 & 0 & 1\end{matrix} ]$ | $\frac{1}{2} [ \begin{matrix}1 & 0 & 0 \\ 0 & 1 & 0 \\ - 1 & 0 & 0 \\ 0 & 0 & 1\end{matrix} ]$ | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ |
| 4-6 | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ | — |

Table 6.3.1.5-7: Precoding matrix W for four-layer transmission using four antenna
ports with transform precoding disabled.

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |
| 4 | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ | — | — | — |

Table 6.3.1.5-1: Precoding matrix W for single-layer transmission using two
antenna ports.

| TPMI | W | | | | | | | |
|---|---|---|---|---|---|---|---|---|
| index | (ordered from left to right in increasing order of TPMI index) | | | | | | | |
| 0-5 | $\frac{1}{\sqrt{2}} [ \begin{matrix}1 \\ 0\end{matrix} ]$ | $\frac{1}{\sqrt{2}} [ \begin{matrix}0 \\ 1\end{matrix} ]$ | $\frac{1}{\sqrt{2}} [ \begin{matrix}1 \\ 1\end{matrix} ]$ | $\frac{1}{\sqrt{2}} [ \begin{matrix}1 \\ - 1\end{matrix} ]$ | $\frac{1}{\sqrt{2}} [ \begin{matrix}1 \\ j\end{matrix} ]$ | $\frac{1}{\sqrt{2}} [ \begin{matrix}1 \\ - j\end{matrix} ]$ | — | — |

Table 6.3.1.5-4: Precoding matrix W for two-layer transmission using two antenna
ports with transform precoding disabled.

| TPMI | W | | |
|---|---|---|---|
| index | (ordered from left to right in increasing order of TPMI index) | | |
| 0-2 | $\frac{1}{\sqrt{2}} [ \begin{matrix}1 & 0 \\ 0 & 1\end{matrix} ]$ | $\frac{1}{2} [ \begin{matrix}1 & 1 \\ 1 & - 1\end{matrix} ]$ | $\frac{1}{2} [ \begin{matrix}1 & 1 \\ j & - j\end{matrix} ]$ |

### 5 Example Implementations and Embodiments of the Disclosed Technology

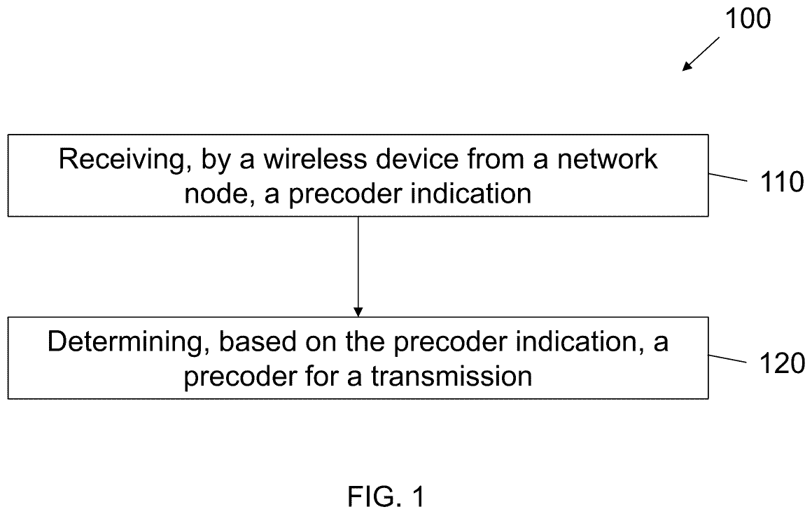

FIG. 1 shows a flowchart for an example method for wireless communication. The method 100 includes receiving (110), by a wireless device from a network node, a precoder indication, and determining (120), based on the precoder indication, a precoder for a transmission, wherein the precoder indication indicates at least one of a number of port groups, one or more ranks, or one or more precoding information, each precoding information associated with a rank of the one or more ranks.

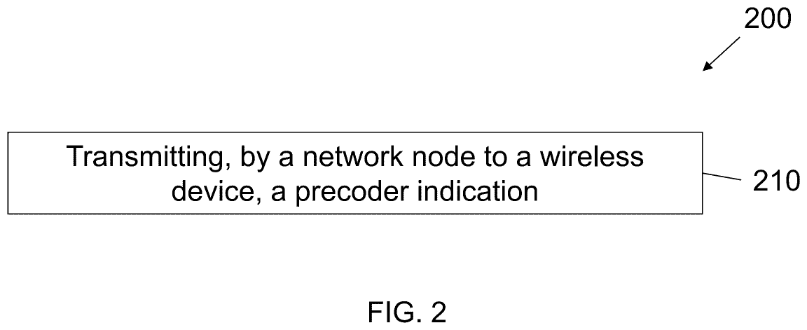

FIG. 2 shows a flowchart for another example method for wireless communication. The method 200 includes transmitting (210), by a network node to a wireless device, a precoder indication, wherein the wireless device is configured to determine, based on the precoder indication, a precoder for a transmission, and wherein the precoder indication indicates at least one of a number of port groups, one or more ranks, or one or more precoding information, each precoding information associated with a corresponding rank of the one or more ranks.

The described embodiments provide, inter alia, the following technical solutions:
1. A method of wireless communication, comprising: receiving, by a wireless device from a network node, a precoder indication; and determining, based on the precoder indication, a precoder for a transmission, wherein the precoder indication indicates at least one of: a number of port groups, one or more ranks, or one or more precoding information, each precoding information associated with a rank of the one or more ranks.
2. A method of wireless communication, comprising: transmitting, by a network node to a wireless device, a precoder indication, wherein the wireless device is configured to determine, based on the precoder indication, a precoder for a transmission, and wherein the precoder indication indicates at least one of: a number of port groups, one or more ranks, or one or more precoding information, each precoding information associated with a corresponding rank of the one or more ranks.
3. The method of solution 1 or 2, wherein each of the port groups corresponds to a respective rank which is equal to or greater than zero.
4. The method of solution 1 or 2, wherein each of the one or more precoding information comprises a transmit precoding matrix indicator (TPMI) or a set of parameter values.
5. The method of solution 1 or 2, wherein the precoding information associated with the corresponding rank being greater than zero.
6. The method of solution 1 or 2, wherein the precoder indication comprises the precoding information and the associated rank being jointly coded in a downlink control information (DCI).
7. The method of solution 1 or 2, wherein the one or more ranks are based on a predetermined rule or a parameter signaled by the network node.
8. The method of solution 1 or 2, wherein the number of port groups is associated with a coherence level that comprises full coherence, a first type of partial coherence, a second type of partial coherence, or non-coherence.
9. The method of solution 1 or 2, wherein the one or more ranks are based on a group-balancing rule, wherein (a) a first rank exceeds a second rank by not more than one or (b) the first rank is less than the second rank by not more than one, and wherein the first rank corresponds to a first port group that has smaller index than a second port group corresponding to the second rank.
10. The method of solution 1 or 2, wherein the one or more ranks are based on a group-selection rule, wherein (a) one rank of the one or more ranks is greater than 1 or (b) at most one rank of the one or more ranks is greater than 1 and less than K/Ng, and other ranks are 0 or K/Ng, wherein the number of port groups (Ng) is 1, 2, 4, or 8, and wherein K is a number of transmit antenna ports for transmission.
11. The method of solution 1 or 2, wherein the number of port groups (Ng) is a configured value or based on a configured coherence level, and wherein the coherence level comprises at least one of full coherence, a first type of partial coherence, a second type of partial coherence, or non-coherence. In some examples, the coherence level can include one or more of the four coherence levels, i.e., full coherence, a first type of partial coherence (also referred to as partial-1 coherence), a second type of partial coherence (also referred to as partial-2 coherence), or non-coherence.
12. The method of solution 1 or 2, wherein the one or more ranks are based on a group-selection rule or group-balanced rule according to a maximum level of a coherence level configured for the wireless device or a minimum number of Ng configured for the wireless device, wherein Ng is the number of port groups, and wherein the coherence level comprises at least one of full coherence, a first type of partial coherence, a second type of partial coherence, or non-coherence.
13. The method of solution 12, wherein, in response to a maximum level of the coherence level being the full coherence, the wireless device is configured to determine the one or more ranks corresponding to Ng=1, 2, 4, or 8 with the group-balancing rule.
14. The method of solution 12, wherein, in response to a maximum level of the coherence level being the first type of partial coherence, the wireless device is configured to determine the one or more ranks corresponding to Ng=2, 4, or 8, wherein the group-selection rule is implemented for Ng=2, and wherein the group-balancing rule is implemented for other Ng.
15. The method of solution 12, wherein, in response to a maximum level of the coherence level being the first type of partial coherence, the wireless device is configured to determine the one or more ranks corresponding to Ng=2, 4, or 8, wherein the group-selection rule is implemented for Ng=2, and wherein the group-balancing rule is implemented for Ng=2, 4, or 8.
16. The method of solution 12, wherein, in response to a maximum level of the coherence level being the second type of partial coherence, the wireless device is configured to determine the one or more ranks corresponding to Ng=4 or 8, wherein the group-selection rule is implemented for Ng=4, and wherein the group-balancing rule is implemented for other Ng.
17. The method of solution 12, wherein, in response to a maximum level of the coherence level being the second type of partial coherence, the wireless device is configured to determine the one or more ranks corresponding to Ng=4 or 8, wherein the group-selection rule is implemented for Ng=4, and wherein the group-balancing rule is implemented for Ng=4 or 8.
18. The method of solution 1 or 2, wherein the precoder indication is indicated by a field in a downlink control information (DCI), and the precoder indication field indicates the number of port groups, the one or more ranks, or the one or more precoding information, and each precoding information associated with a rank of the one or more ranks.
19. The method of solution 18, wherein a bit length of the precoder indication field is based on a number of entries of one or more tables determined by the wireless device.
20. The method of solution 19, wherein the number of entries is based on at least one of: a maximum rank for the transmission, or a maximum rank for one port group, each of a set of rules, or a mode configured to use one or more of the set of rules, and wherein the set of rules comprises a port group indexing rule, a group-balancing rule, a group-selection rule, a nested construction rule, or a TPMI reduction rule.
21. The method of solution 20, wherein in response to a port group indexing rule being enabled, a rank X and a rank Y are associated with a specific indexed order of port groups. In some examples, if the port group indexing rule is enabled, if there is an entry indicating a first rank for a first port group with rank value of X and a second rank for a second port group with rank value of Y (Y is not equal to X), there is no entry indicating a first rank for a first port group with rank value of Y and a second rank for a second port group with rank value of X.

Alternatively, if the port group indexing rule is not enabled, there is at least one entry indicating a first rank for a first port group with rank value of Y and a second rank for a second port group with rank value of X.
22. The method of solution 20, wherein, in response to a nested construction rule being implemented, the number of port groups (Ng) is a configured value or based on a configured coherence level, wherein the coherence level comprises at least one of full coherence, a first type of partial coherence, a second type of partial coherence, or non-coherence, or the one or more ranks are based on a group-selection rule or group-balanced rule according to a maximum level of the coherence level configured for the wireless device or a minimum number of Ng configured for the wireless device.
23. The method of solution 20, wherein the mode is relevant to an antenna layout of the wireless device.
24. The method of solution 19, wherein the precoder indication field corresponds to an entry of one table or a combination of multiple tables.
25. The method of solution 19, wherein the number of port groups is associated with a coherence level comprising at least one of full coherence, a first type of partial coherence, a second type of partial coherence, or non-coherence.
26. The method of solution 25, wherein the one table comprises entries associated with each of the configured coherence levels or associated with each of configured Ng.
27. The method of solution 25, wherein each of a plurality of tables comprises entries associated with one of the configured coherence levels or one of configured Ng.
28. The method of solution 25, wherein each of a plurality of tables comprises entries associated with different combinations of coherence levels from the configured coherence levels.
29. An apparatus for wireless communication comprising a processor, configured to implement a method recited in one or more of solutions 1 to 28.
30. A non-transitory computer readable program storage medium having code stored thereon, the code, when executed by a processor, causing the processor to implement a method recited in one or more of solutions 1 to 28.

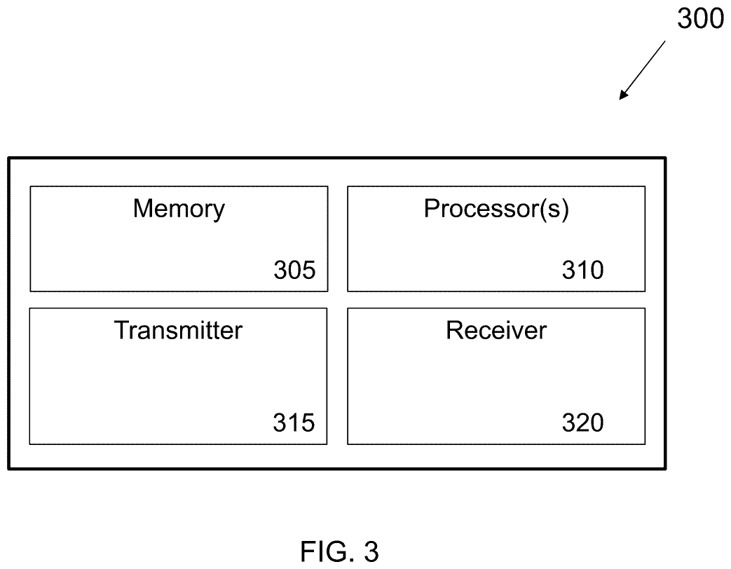

FIG. 3 shows a block diagram of an example hardware platform 300 that may be a part of a network device (e.g., base station) or a communication device (e.g., a user equipment (UE)). The hardware platform 300 includes at least one processor 310 and a memory 305 having instructions stored thereupon. The instructions upon execution by the processor 310 configure the hardware platform 300 to perform the operations described in FIGS. 1 and 2 and in the various embodiments described in this patent document. The transmitter 315 transmits or sends information or data to another device. For example, a network device transmitter can send a message to a user equipment. The receiver 320 receives information or data transmitted or sent by another device. For example, a user equipment can receive a message from a network device.

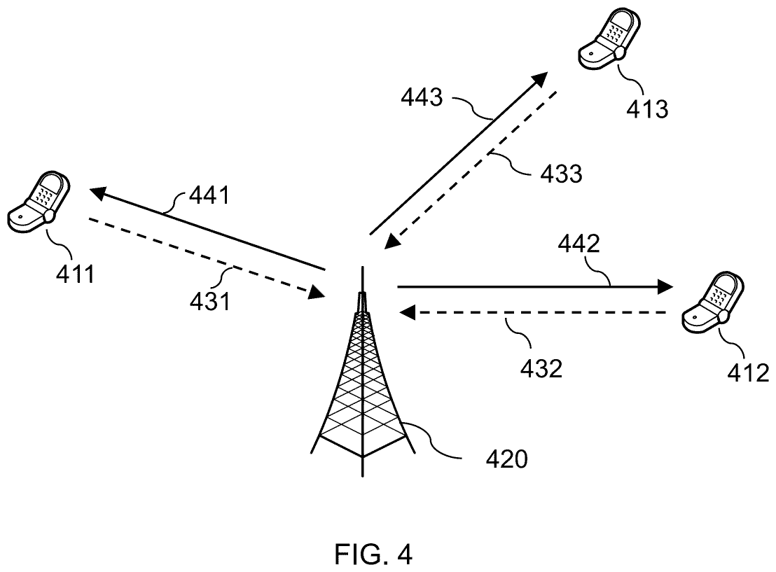

The implementations as discussed above will apply to a wireless communication. FIG. 4 shows an example of a wireless communication system (e.g., a 5G or NR cellular network) that includes a base station 420 and one or more user equipment (UE) 411, 412 and 413. In some embodiments, the UEs access the BS (e.g., the network) using a communication link to the network (sometimes called uplink direction, as depicted by dashed arrows 431, 432, 433), which then enables subsequent communication (e.g., shown in the direction from the network to the UEs, sometimes called downlink direction, shown by arrows 441, 442, 443) from the BS to the UEs. In some embodiments, the BS send information to the UEs (sometimes called downlink direction, as depicted by arrows 441, 442, 443), which then enables subsequent communication (e.g., shown in the direction from the UEs to the BS, sometimes called uplink direction, shown by dashed arrows 431, 432, 433) from the UEs to the BS. The UE may be, for example, a smartphone, a tablet, a mobile computer, a machine to machine (M2M) device, an Internet of Things (IoT) device, and so on.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A method of wireless communication, comprising:
receiving, by a wireless device from a network node, a precoder indication; and
determining, based on the precoder indication, a precoder for a transmission,
wherein the precoder indication indicates a number of port groups, a plurality of ranks, and a plurality of precoding information, each precoding information associated with a corresponding rank of the plurality of ranks,
wherein a precoding information and an associated rank are jointly coded in a downlink control information (DCI) and wherein the associated rank is greater than zero.

2. The method of claim 1, wherein each of the port groups corresponds to a respective rank which is greater than zero.

3. The method of claim 1, wherein each of the plurality of precoding information comprises a transmit precoding matrix indicator (TPMI) or a set of parameter values in a case that the number of port groups is associated with a coherence level that comprises full coherence.

4. The method of claim 1, wherein the precoding information associated with the corresponding rank is greater than zero.

5. The method of claim 1, wherein the plurality of ranks are based on a predetermined rank splitting rule or a parameter signaled by the network node, and wherein the precoding information and a number of the plurality of ranks is jointly coded in the parameter.

6. The method of claim 1, wherein the number of port groups is associated with a coherence level that comprises full coherence, a first type of partial coherence, a second type of partial coherence, or non-coherence.

7. The method of claim 1, wherein the plurality of ranks is based on a group-balancing rule, wherein (a) a first rank exceeds a second rank by not more than one or (b) the first rank is less than the second rank by not more than one, and wherein the first rank corresponds to a first port group that has smaller index than a second port group corresponding to the second rank.

8. The method of claim 1, wherein the plurality of ranks is based on a group-selection rule, wherein (a) one rank of the plurality of ranks is greater than 1 or (b) at most one rank of the plurality of ranks is greater than 1 and less than K/N_{g}, and other ranks are 0 or K/N_{g}, wherein the number of port groups (N_{g}) is 1, 2, 4, or 8, and wherein K is a number of transmit antenna ports for transmission.

9. The method of claim 1, wherein the number of port groups (N_{g}) is a configured value or based on a configured coherence level, and wherein the configured coherence level comprises at least one of full coherence, a first type of partial coherence, a second type of partial coherence, or non-coherence.

10. The method of claim 1, wherein the plurality of ranks is based on a group-selection rule or a group-balancing rule according to a maximum level of a coherence level configured for the wireless device or a minimum number of N_{g} configured for the wireless device, wherein N_{g} is the number of port groups, and wherein the coherence level comprises at least one of full coherence, a first type of partial coherence, a second type of partial coherence, or non-coherence.

11. The method of claim 10, wherein, in response to a maximum level of the coherence level being the full coherence, the wireless device is configured to determine the plurality of ranks corresponding to N_{g}=1, 2, 4, or 8 with the group-balancing rule.

12. The method of claim 10, wherein, in response to a maximum level of the coherence level being the first type of partial coherence, the wireless device is configured to determine the plurality of ranks corresponding to N_{g}=2, 4, or 8, wherein the group-selection rule is implemented for N_{g}=2, and wherein the group-balancing rule is implemented for either other N_{g} or N_{g}=2, 4, or 8.

13. The method of claim 10, wherein, in response to a maximum level of the coherence level being the second type of partial coherence, the wireless device is configured to determine the plurality of ranks corresponding to N_{g}=4 or 8, wherein the group-selection rule is implemented for N_{g}=4, and wherein the group-balancing rule is implemented for either other N_{g} or N_{g}=4 or 8.

14. A method of wireless communication, comprising:
transmitting, by a network node to a wireless device, a precoder indication,
wherein the wireless device is configured to determine, based on the precoder indication, a precoder for a transmission, and
wherein the precoder indication indicates a number of port groups, a plurality of ranks, and a plurality of precoding information, each precoding information associated with a corresponding rank of the plurality of ranks, and
wherein a precoding information and an associated rank are jointly coded in a downlink control information (DCI) and wherein the associated rank is greater than zero.

15. The method of claim 14, wherein each of the port groups corresponds to a respective rank which is greater than zero.

16. The method of claim 14, wherein each of the plurality of precoding information comprises a transmit precoding matrix indicator (TPMI) or a set of parameter values in a case that the number of port groups is associated with a coherence level that comprises full coherence.

17. The method of claim 14, wherein the precoding information associated with the corresponding rank is greater than zero.

18. The method of claim 14, wherein the plurality of ranks are based on a predetermined rank splitting rule or a parameter signaled by the network node, and wherein the precoding information and a number of the plurality of ranks is jointly coded in the parameter.

19. The method of claim 14, wherein the number of port groups is associated with a coherence level that comprises full coherence, a first type of partial coherence, a second type of partial coherence, or non-coherence.

20. An apparatus for wireless communication, implemented by a wireless device, the apparatus comprising:
one or more processors configured to:
receive, from a network node, a precoder indication; and
determine, based on the precoder indication, a precoder for a transmission,
wherein the precoder indication indicates a number of port groups, a plurality of ranks, and a plurality of precoding information, each precoding information associated with a corresponding rank of the plurality of ranks,
wherein a precoding information and an associated rank are jointly coded in a downlink control information (DCI) and wherein the associated rank is greater than zero.
